(19) United States
(12) Patent Application Publication
(10) Pub. No.: US 2012/0241248 A1
(43) Pub. Date: Sep. 27, 2012

(54) TWO-STROKE ENGINE WITH A SILENCER

(75) Inventors: Michael SCHOENFELD, Rohlstorf (DE); Christian KELLERMANN, Grande (DE)

(73) Assignee: MAKITA CORPORATION, Anjo-shi (JP)

(21) Appl. No.: 13/411,955

(22) Filed: Mar. 5, 2012

(30) Foreign Application Priority Data
Mar. 9, 2011 (DE) 202011000528.3

(51) Int. Cl. B64D 33/02

(52) U.S. Cl. 181/214

(57) ABSTRACT

A silencer includes a silencer inlet followed by a flow channel. The inlet can be attached to an outlet of a combustion chamber of a two-stroke engine. The flow channel at the channel end located opposite the silencer inlet leads into a first chamber where a second chamber is provided into which exhaust gas flows through a main outlet branched off the flow channel. The second chamber preferentially encloses the first chamber. The flow channel is flow-favourably moulded between the silencer inlet and the first chamber so that the exhaust gas flowing into the silencer inlet, because of its mass inertia, predominantly flows into the first chamber and, after filling the first chamber, flows back again in the direction towards the combustion chamber. The silencer allows a piston of the engine to include a piston skirt that is substantially designed closed.

The present invention relates to a two-stroke engine, in particularly for a hand-operated power tool such as a garden and green area maintenance tool or for a small-engine motorcycle, a marine engine and the like, with a cylinder in which a piston is stroke-moveably guided and for forming a crank drive is connected to a crankshaft via a connecting rod, and with a silencer, wherein the silencer comprises a silencer inlet which is followed by a flow channel, so that the flow channel by means of the silencer inlet can be attached to an oulet of a combustion chamber of the two-stroke engine, wherein the flow channel on the channel end located opposite the silencer inlet leads into a first chamber, wherein furthermore a second chamber is provided, into which the exhaust gas flows through a flow channel that is branched-off the main outlet, wherein the first chamber is exemplarily enclosed by the second chamber, and wherein the flow channel is moulded on between the silencer inlet and the first chamber flow-favourably in such a manner that the exhaust gas flowing into the silencer inlet because of its mass inertia predominantly flows into the first chamber and following a filling of the first chamber flows back again, and because of this a back pressure forms in the direction towards the combustion chamber, according to the preamble of claim 1.

### Prior Art

From DE 20 2008 005 168 U1 a generic two-stroke engine having a silencer of the type that is of interest here, is shown. The two-stroke engine is represented simplified and the silencer is arranged on the outlet of the two-stroke engine, so that the fuel-air mixture combusted in the combustion chamber of the two-stroke engine can enter the silencer. Here, the exhaust gas enters a flow channel of the silencer via which the silencer is attached to the cylinder of the two-stroke engine by means of the silencer inlet. The silencer inlet is followed by a flow channel which via a channel end leads into a first chamber. Between the silencer inlet and the channel end a main outlet is arranged on the flow channel, and exhaust can get from the flow channel gas through the main outlet into a second chamber, which is designed larger than the first chamber and which encloses the first chamber.

The flow channel is embodied straight, so that the exhaust gas shooting into the flow channel via the silencer inlet initially, at least predominantly, flows into the first chamber and generates a positive pressure in the first chamber. Through this positive pressure, a large part of the exhaust gas flows back in the direction towards the silencer inlet and forms a gas barrier through which it is prevented that fuel-air mixture recharged into the combustion chamber of the cylinder reaches the silencer in uncombusted form. The geometrical configuration of the flow channel and of the first chamber with the respective volumes is defined in such a manner that a flow behaviour of the exhaust gas in the flow channel and the first chamber is created, which corresponds to the stroke movement of the piston and the opening of the outlet of the combustion chamber in the region of the bottom dead centre of the piston. Thus, better emission values are achieved, in particular, the efficiency of the two-stroke engine can be increased compared with conventional silencers through a reduction of the emission of uncombusted fuel.

The present design of the silencer, through the introduced specific configuration of the flow channel, causes a very strong return flow of the exhaust gas in the direction towards the combustion chamber between the silencer inlet and the first chamber in particularly as a function of the rotational speed field of the two-stroke engine. Depending on the range of the rotational speed field in which the two-stroke engine is operated it can happen that the return flow of the exhaust gas at least partially already loads the piston that is stroke-moveably guided in the cylinder, which on leaving the bottom dead centre again closes the outlet of the combustion chamber and thus the silencer inlet. If the flow of the exhaust gas in the flow channel does not accurately correspond to the stroke movement of the piston, a pressure shock of the exhaust gas against the piston occurs. Investigations in this regard have shown that pistons having break-throughs in the piston skirt can have deposits and areas that are washed clean. From this it could be inferred that entering of the exhaust gas in the piston run and even in the crankcase occurs, so that even a mixing-through of fuel-air mixture and exhaust gas can take place.

### Disclosure of the Invention

It is therefore the object of the present invention to further develop a two-stroke engine in such a manner, that it can be advantageously operated with a silencer of the type indicated above. In particular, it is the object of the invention to prevent a mixing-through of fuel-air mixture and exhaust gas through the configuration of the piston.

Starting out from a two-stroke engine, this object is solved with a silencer of the type designated above according to the preamble of claim 1 in conjunction with the characterising features. Advantageous further developments of the invention are stated in the dependent claims.

The invention encloses the technical teaching that the piston comprises a piston skirt which is substantially designed closed.

When using a piston with a piston skirt that is substantially designed closed, it could be established during the operation of the two-stroke engine with the silencer designated above that no deposits and clean-washed areas on the piston formed any longer. In particular it was determined that the entry of exhaust gases in the crank chamber of the crankcase can be avoided and in particular it could be avoided that an additional discharge of fuel-air mixture from the crankcase chamber takes place. In principle, two-stroke engine of the type present here are designed for use in power tools with pistons having as low a weight as possible. To this end, it is regularly provided to introduce a window in the piston skirt in order to save additional weight for forming the piston. In particular, break-throughs are provided in the region of the piston pins, which serve for the articulated connection of the piston to the connecting rod, in order to further reduce the piston mass. These so-called window pistons are usually employed for the construction of two-stroke engines for the present application and according to the invention the use of such window pistons is omitted and it is proposed to use pistons with a closed piston skirt.

For the articulated connection of the piston to the connecting rod a piston pin is mostly provided, wherein according to an advantageous embodiment the piston skirt is embodied closed at least from its other piston edge to below the piston pin. The piston with closed piston skirt can have a cylindrical basic shape and the piston edge is formed by the top of the piston, which radially delimits the piston surface, which in turn moveably delimits the combustion chamber of the two-stroke engine. Consequently, the piston edge also forms the edge that opens and closes the opening of the combustion chamber in the direction towards the silencer through the stroke movement of the piston. The advantages of using a closed piston spurt can materialise even when the piston skirt is embodied closed at least in the region from the upper edge to below the piston pin. Here, the piston pin is located approximately at half the height of the piston between the piston edge and the lower termination edge of the piston, which delimits the piston towards the bottom and is arranged located opposite the piston edge on the top of the piston.

With additional advantage the piston can comprise openings provided in the piston skirt for receiving the piston pin, and the piston skirt is designed completely closed except for the openings. The openings in the piston skirt are necessary in order to assemble the piston pin and the piston pin is inserted through the openings and with assembled connecting rod additionally extends through a connecting rod eye, so that between the connecting rod eye and the piston pin the articulated connection is created. Following this, the piston pin can be secured in its axial position in the piston through locking rings, so that through the arrangement of the piston pin the opening in the piston skirt are closed again and there is no longer any connection between the opening in the piston skirt and the crank chamber, so that the achieved advantages through an otherwise closed piston skirt are retained.

According to a further advantageous measure, the piston in the piston skirt can comprise flats and the flats are provided in particular in two regions of the piston located opposite each other, which are formed by the regions in which the openings are introduced in the piston skirt. Thus, a so-called box piston can be formed and in contrast two pistons having a round skirt, box-pistons are set back in pin direction in the skirt region. Thus, the piston can have a circular cross section for the cylinder head on the upper side and merges into a rectangular cross section in the direction towards the bottom-side termination edge. Here, the rectangular cross section has a longitudinal side for the cylinder run, which corresponds to the extension direction of the piston pin. Through this measure, the piston can be embodied with a lower mass, wherein it was determined that the provision of flats does not have any negative effects on the achieved positive effect of avoiding the deposit and clean-washed areas in the surface of the piston skirt despite using the silencer designated above. This positive effect is retained in particular if the piston skirt in the region of the flats is designed closed, in particular, the piston skirt can be embodied free of windows in the region of the flats.

The piston skirt can have a bottom side termination edge which is designed rotation-symmetrically circumferential and has a distance to the piston edge that remains the same over the circumference of the piston. Thus, the piston can correspond to the basic shape of a cylinder and the circular termination edge is designed parallel to the piston edge, which terminates the top of the piston skirt. Alternatively, the termination edge can have indentations, wherein the regions of the indentations are preferentially formed by the regions in which the openings are introduced in the piston skirt. Thus, the regions of the indentations, which are formed located opposite on the piston, are located in extension direction of the piston pin.

Both the flats as well as the indentations in the termination edge on the bottom of the piston form the regions of piston which are located in the cylinder of the two-stroke engine laterally of the outlet and in particular also of the inlet. The regions of the piston which open and close the outlet in the direction towards the silencer, but also the inlet for the entry of the fuel-air mixture from the crankcase through the stroke movement in the cylinder are formed by the regions of the piston that have neither flats nor indentations in the termination edge of the piston. However, it is provided according to the invention that the regions also adjacent to the regions of the piston, which open and close the openings in the cylinder through the stroke movement, are embodied windowless.

### BRIEF DESCRIPTION OF THE DRAWINGS

Further measures improving the invention are shown in more detail in the following jointly with the description of preferred exemplary embodiments of the invention by means of the Figures. It shows:

FIG. 1 a two-stroke engine having a silencer and a piston of the embodiment according to the invention,

FIG. 2 a detailed view of a piston according to the prior art,

FIG. 3 a lateral view of a piston having the features of the present invention and

FIG. 4 a piston according to the present invention in a perspective view.

### PREFERRED EXEMPLARY EMBODIMENTS OF THE INVENTION

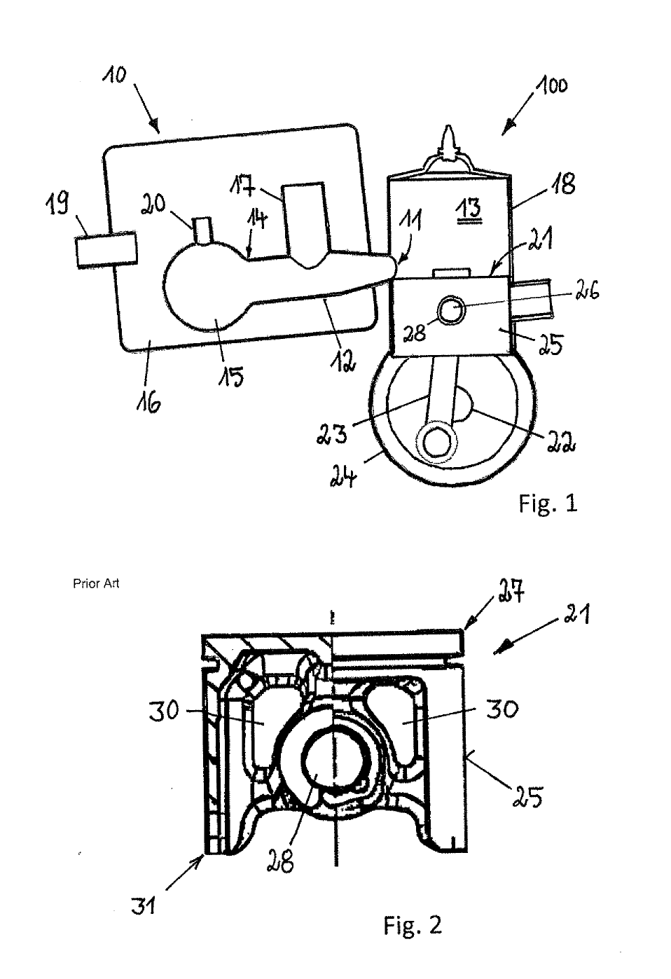

FIG. 1 shows a two-stroke engine 100 in a schematic transversely sectioned view and a silencer 10 is attached to the two-stroke engine 100. The two-stroke engine 100 comprises a cylinder 18, in which a combustion chamber 13 is formed. The combustion chamber 13 is moveably delimited by the piston 21, which via a connecting rod 23 is connected to a crankshaft 22 for forming a crank drive, and the crankshafts 22 is mounted in a crankcase 24. In the wall of the cylinder 18 an outlet is arranged, to which the silencer 10 is flanged in a manner not shown in more detail by way of a silencer inlet 11. When the piston 21 is in the region of the bottom dead centre, the piston 21 exposes the outlet of the combustion chamber 13, and the exhaust gas can enter the silencer 10 from the combustion chamber 13 through the silencer inlet 11.

The silencer inlet 11 is followed by a flow channel 12, which with a channel end 14 located opposite the silencer inlet 11 leads into a first chamber 15. Furthermore, the silencer 10 comprises a second chamber 16 which is designed larger than the first chamber 15 and which exemplarily completely encloses the first chamber 15 and likewise exemplarily encloses a part of the flow channel 12. The exhaust gas entering the silencer inlet 11 can initially enter the first chamber 15 at least for the greatest part, wherein on the flow channel 12 a main outlet 17 is arranged, and the exhaust gas can enter the second chamber 16 from the flow channel 12 through the main outlet 17. Furthermore, the first chamber 15 comprises an auxiliary outlet 20, so that exhaust gas can directly flow into the second chamber 16 also from the first chamber 15. The exhaust gas can leave the silencer 10 and enter the open air through an outlet 19, which is introduced in the wall of the second chamber 16.

The flow channel 12 extends in straight design between the first chamber 15 and the silencer inlet 11 and is thus formed flow-favourably in such a manner that the exhaust gas flowing into the silencer inlet 11, because of its mass inertia, predominantly flows into the first chamber 15 in which it creates a positive pressure. Following the filling of the first chamber 15, the exhaust gas can flow back again in the direction towards the silencer inlet 11, and by doing so form a back pressure against the combustion chamber 13. Thus it is avoided that fuel-air mixture enters the silencer 10 in uncombusted form or fuel-air mixture that has already entered the silencer 10 is forced back into the combustion chamber 13. Only after the return flow of the exhaust gas towards the outlet of the combustion chamber 13 can the exhaust gas leave the flow channel 12 or the first chamber 15 through a main outlet 17 and enter the second chamber 16. The exhaust gas finally leaves the silencer 10 through an outlet 19, which is introduced in the second chamber 16, and the exhaust gas can get into the open air through the outlet 19.

The piston 21 of the two-stroke engine 100 is shown with a piston skirt 25 according to the invention, and the sole remaining opening in the piston skirt 25 is the opening 28 that serves for receiving a piston pin 26.

FIG. 2 shows a piston 21 according to the prior art, which is employed as standard for two-stroke engines used in hand-held power tools. The piston 21 comprises a piston skirt 25, which extends from a top piston edge 27 to a termination edge 31 at the bottom. Approximately at middle height, the opening 28 for receiving a piston pin is located in the piston skirt 25. Also shown are windows 30 introduced in the piston skirt 25 adjacent to the opening 28, so that such pistons 21 according to the prior art are also called window pistons. Such a piston 21 is used as standard for fast-running two-stroke engines 100 of compact design and through the introduced windows 30 the moved mass of the piston 21 can be reduced.

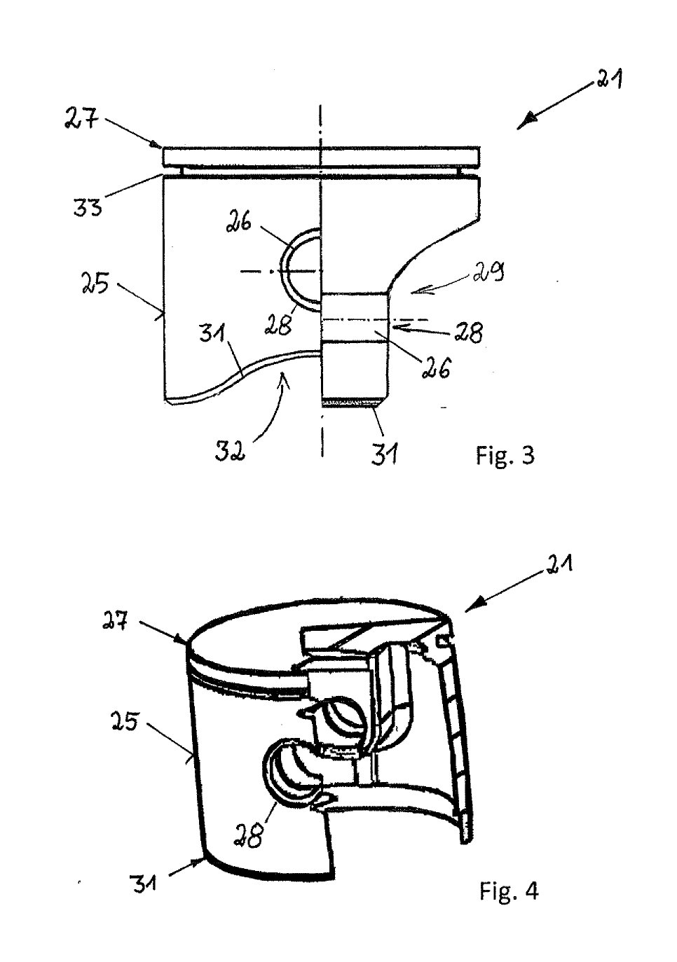

FIG. 3 shows a piston 21 in different half sections with features of the present invention. The piston skirt 25, except for the opening 28 for receiving the piston pin 26, is embodied closed and extends from the top piston edge 27 to the bottom termination edge 31. Slightly below the top piston edge 27, the piston 21 comprises a ring groove 33 for receiving piston rings.

The left half section of the shown piston 21 corresponds to an exemplary embodiment, wherein the termination edge 31 on the bottom of the piston 21 comprises an indentation 32 for weight saving. Despite the piston skirt 25 thus being embodied shorter, no negative influences could be determined, in particular it was not determined that exhaust gas from the silencer 10 could get back into the crankcase 24 of the two-stroke engine.

The exemplary embodiment of the piston 21 in the half section on the right shows a box piston with a flat 29, and the flat 29 is introduced on the side of the piston 21, on which the opening 28 for receiving the piston pin 26 is located. The termination edge 31 in this case is embodied without indentation 32, and the measure of the flat 29 leads to a further reduction of the weight of the piston 21, without the effect of preventing the entry of exhaust gas from the silencer 10 in the crankcase 24 of the two-stroke engine 100 being negatively affected.

FIG. 4 shows a piston 21 with a completely closed piston skirt 25, wherein merely the opening 28 for receiving a piston pin remains in the piston skirt. The piston skirt 25 thus extends in a closed manner and rotation-symmetrically from the piston edge 27 on the top to the termination edge 31 on the bottom of the piston 21, and the termination edge 31 is embodied without indentation 32.

In its embodiment, the invention does not restrict itself to the preferred exemplary embodiments stated above. On the contrary, a number of versions is conceivable that makes use of the shown solution even in the case of embodiments that are of a fundamentally different type. All features and/or advantages, including design details or spatial arrangements emanating from the claims, the description or the drawings can be substantial for the invention both by themselves as well as in the most diverse combinations.

### LIST OF REFERENCE NUMBERS

100 Two-stroke engine
10 Silencer
11 Silencer inlet
12 Flow channel
12′ Channel opening
13 Combustion chamber
14 Channel end
15 First chamber
16 Second chamber
17 Main outlet
18 Cylinder
19 Outlet
20 Auxiliary outlet
21 Piston
22 Crankshaft
23 Connecting rod
24 Crank case
25 Piston skirt
26 Piston pin
27 Piston edge
28 Opening
29 Flat
30 Window
31 Termination edge
32 Indentation
33 Ring groove

1. A two-stroke engine, comprising
a cylinder in which a piston is stroke-moveably guided and for forming a crank drive is connected to a crankshaft via a connecting rod, and
a silencer, wherein
the silencer comprises a silencer inlet, which is followed by a flow channel,
the flow channel can be attached to an outlet of a combustion chamber of the two-stroke engine by means of the silencer inlet,
wherein the flow channel on the channel end located opposite the silencer inlet leads into a first chamber,
wherein a second chamber is provided,
into which the exhaust gas flows through a main outlet branched off the flow channel,
wherein the first chamber is enclosed by the second chamber, and wherein
the flow channel is moulded flow-favourably between the silencer inlet and the first chamber in such a manner that the exhaust gas flowing into the silencer inlet because of its mass inertia predominantly flows into the first chamber and after a filling of the first chamber flows back again and because of this a back pressure in the direction towards the combustion chamber is formed, wherein the piston comprises a piston skirt which is substantially embodied closed.

2. The two-stroke engine according to claim 1, wherein a piston pin is provided by means of which the piston is connected to the connecting rod in an articulated manner, wherein the piston skirt is embodied closed at least from its piston edge to below the piston pin.

3. The two-stroke engine according to claim 1, wherein the piston comprises openings for receiving the piston pin provided in the piston skirt, and the piston skirt is designed completely closed except for the openings.

4. The two-stroke engine according to claim 1, wherein the piston comprises flats in the piston skirt, and the flats are provided in particular in two regions of the piston located opposite each other, which are formed by the regions in which the openings are introduced in the piston skirt.

5. The two-stroke engine according to claim 1, wherein the piston is designed as box piston.

6. The two-stroke engine according to claim 4, wherein the piston skirt is designed closed in the region of the flats, wherein the piston skirt is embodied free of windows in the region of the flats.

7. The two-stroke engine according to claim 1, wherein the piston skirt has a bottom termination edge which is of a rotation-symmetrical circumferential design and has a distance to the piston edge that remains the same over the circumference of the piston.

8. The two-stroke engine according to claim 1, wherein the termination edge comprises indentations, wherein the regions of the indentation are formed by the regions in which the openings are introduced in the piston skirt.
